(19) United States
(12) Patent Application Publication
(10) Pub. No.: US 2006/0178892 A1
(43) Pub. Date: Aug. 10, 2006

(54) Method of uniquely associating transaction data with a particular individual, and computer-based messaging system for communicating such associated data

(76) Inventor: Yeong Kuang Oon, Scoreby (AU)

Correspondence Address: NIXON & VANDERHYE, PC, 901 NORTH GLEBE ROAD, 11TH FLOOR, ARLINGTON, VA, 22203, US

(21) Appl. No.: 10/550,274

(22) PCT Filed: Apr. 8, 2004
(86) PCT No.: PCT/AU04/00468

§ 371 Date: Sep. 23, 2005

(30) Foreign Application Priority Data
Apr. 11, 2003 (AU) 2003901724
Jul. 4, 2003 (AU) 2003903432
Sep. 30, 2003 (AU) 2003905320

(51) Int. Cl. G06Q 99/00; G06Q 20/00

(52) U.S. Cl. 705/1; 705/16

(57) ABSTRACT

The invention concerns a method of uniquely associating transaction data with a particular individual. Further, the invention relates to a computer-based messaging system for communicating data associated in accordance with this method. In one form, a method of uniquely associating transaction data with a particular individual is provided, comprising the steps of generating or obtaining transaction data for that individual, and associating the transaction data with a unique personal identification key of that individual, the key expressed in human readable form and comprising the individual's first or given name, the individual's father's first or given name, the individual's mother's first or given name, the individual's date of birth, the individual's gender, and the individual's place of birth expressed in longitude and latitude. The invention finds particular application in the healthcare environment, enabling users, authorities and service providers to fully resolve the identities of patients receiving or seeking medical care.

### FIELD OF THE INVENTION

The present invention relates to a method of uniquely associating transaction data with a particular individual, and more particularly such a method able to fully resolve the identities of patients receiving medical care. Further, the invention relates to a computer-based messaging system for communicating data associated in accordance with this method.

### BACKGROUND

The present invention is suitable for use with systems and techniques of the sort described in applicant's WO-9748059 entitled ‘Iterative problem solving technique’, WO-9844432 entitled ‘Didactic and content oriented word processing method with incrementally changed belief system’, WO-0139037 entitled ‘A unitary language for problem solving resources for knowledge based services’, WO-014652 entitled ‘Automation oriented healthcare delivery system based on medical scripting language’, and WO-03034274 entitled ‘System and method of improved recording of medical transactions’, but as will be clear to a skilled reader the invention is not limited to such use. The content of the above publications are included herein by reference thereto.

Good medical care is the concern of any global citizen. Increasingly, medical records, medical test results and messaging amongst the service provider community are computerised. The patient in a modern society often needs to access or has accessed a multitude of care providers, which may over time comprise several family doctors, several pathology and radiological laboratories and several medical specialists and hospitals. This multiplicity of providers and points of care is encouraged by the increasing mobility of the population, where individuals and families seek employment or domicile at different locations nationally or internationally. This has naturally resulted in highly fragmented medical record, wherein each care provider employs a different system of patient identifier, most frequently a string of numbers. Healthcare is expensive, and duplications of tests, drugs, procedures and sequestration of patient health data by individual healthcare providers inevitably leads to wastage and sub-optimal care.

Meaningful synchronisation and unification of distributed medical data can only be promoted by a universal unique patient identifier, but unfortunately each health care provider generates its own unique identifier under its own system, and employs its own method of transactional representation. At each site of care patient data is recorded, usually by storage in a computer database. At each site, data pertaining to a particular patient is associated with a patient identifier that is unique for that particular healthcare organisation. In addition, public health organisations have, in general, not taken appropriate steps to address this issue. In Australia, for example, the proliferation of Medicare care card numbers bears testament to the problem.

Healthcare in the 21st century needs to address issues of universalisation, collaboration, aggregation and translation of the medical data pertaining to a particular patient across all geographical and care-provider boundaries. If this can be achieved, it is then possible to make health data available anywhere at any time to accredited care providers. A significant problem, then, is the lack of a universal provider-verifiable patient identifier (or ‘key’) for tagging transactions.

Respective governments in all jurisdictions appear unwilling or unable to introduce nationwide unique patient identifiers for the specific purpose of inter-operability and transportability of partial or whole medical records/transactions across the various healthcare sectors. The problem appears related to a number of factors, namely:
the inability of the service providers, without reliance on a central key-issuing authority, to generate a universal patient unique identifier.
the confusion of the multiplicity of incompatible keys being generated by disparate organisations.
the fear of ‘big brother’, or invasion of privacy, that has led in some jurisdictions (such as Australia) to a rejection of a proposed introduction of the ID card.
the lack of a freewill walk-in/walk-out personal identifier option, whereby patients can decide when their healthcare connectivity needs outweigh their fears of invasion of privacy.

In existing and previous systems, the lack of a universal unique health identifiers have resulted in data islands in the healthcare environment. A dependence on national medical care numbers (eg Medicare numbers or NHS numbers) is unreliable, as such numbers are very difficult to independently verify, consisting only of a numeric string. In the Australian context, the proliferation of Medicare numbers has led to greater entropy in the healthcare personal identifier domain.

Prior art patient identifier systems do not allow the patient to choose to opt out of the system. A universal patient identifier system that offers the option of the carrot is superior to one that simply mandates a big stick. As noted above, prior art systems place total reliance on a central authority to act as an issuer/guarantor of the uniqueness of the patient identifier key. Prior art systems do not allow for pro re nata and de novo construction of personal identifier keys at the ‘grass-root’ level independently by a service provider (ie without reference to other service providers or authorities), the key then affording unification of fragmented records created by other service providers at a later date. In addition, prior art personal identifier systems are not ‘failsafe’. Systems involving numeric personal identifier keys either match the key or fail completely, there is no middle ground.

Prior art medical messaging systems do not allow for cogent medical codes to be embedded inside electronic mail messages and electronic documents meant for the human eye. Such electronic messages may be, for example, electronic pathology/radiology reports, emails, or word processor documents. Prior art systems do not allow such documents to be used to update patient database in a coded format and to enable decision support in a seamless automated manner.

In this specification, where a document, act or item of knowledge is referred to or discussed, this reference or discussion is not an admission that the document, act or item of knowledge or any combination thereof was at the priority date part of the common general knowledge, or known to be relevant to an attempt to solve any problem with which this invention is concerned.

### SUMMARY OF THE INVENTION

In accordance with a first and second aspect of the invention, there is provided a method of uniquely associating transaction data with a particular individual, and a computer-based messaging system for communicating data relating to particular individuals, as defined in the appended claims.

The invention therefore relates to the provision of a system of personal identification, in which the identifier keys can be generated de novo by a service provider or by a plurality of service providers, or by any user on a pro re nata basis. Those involved in the generation of the identifier key need not be in any form of communication, and can separated in time and in space, the resultant key generated being the same and unique for the particular individual person, containing global positioning system information, being jurisprudence independent and failsafe. This solution clearly goes far beyond the concept of a central national or regional ID system. The invention enables powerful cross-referencing of information, and significantly enhances the retrieval and merging of data collected pertaining to that individual in a healthcare or other context.

This invention comprises means for any user or healthcare worker to work in complete autonomy at any time and at any place to compute and derive the same unique patient identifier key based on data that is easily obtained from the patient or information provider, or that is held in the modern birth certificate. The invention therefore allows the clinician or his/her support staff to issue a unique patient identifier key with confidence, and with zero reliance on a central control authority. The integrity of the personal identifier of the present invention is ensured by continual professional verification at the service delivery level. A system employing the method of the invention allows the resolving of non-unique keys, as discussed in further detail below. The professional/health care practitioner or his/her staff can thus generate a unique patient identification key suitable for personal healthcare informatics (and/or other knowledge management purposes) regarding an individual living or deceased, based on data that can readily be provided by the individual, by his relatives, from an extract of a birth certificate, or from historical records. Data of a personal and geographical nature embedded in the individual identifier can also aid in public health research and personal healthcare. Personal identifier keys so generated by a plurality of health practitioners or government bureaucracies enables the ready sharing of data and medical record transactions. In accordance with the invention, no two individuals in the world (both living and deceased) will have the same personal identifier key. In addition to use in knowledge management concerning that individual, the invention can be used in application to functions such as personal web services and email addresses, and for tracking data for knowledge management such as for law enforcement purposes. The invention can help stem the rising tide of personal ID theft.

The unique patient identifier key can therefore be generated by a service provider independently of without reference to a central authority, and this can be done manually or using a stand-alone computer application or web-enabled application.

It is equally possible for the patient himself or herself to generate the unique patient identifier key independently of and without reference to a central authority or a service provider, and again this can be done manually or using a stand-alone computer application or web-enabled application.

Moreover, service providers and patients can generate the unique patient identifier keys independently of one another and without reference to a central authority, thereby overcoming any impediment to universal transportability of medical transactions and electronic health records.

The value of data mining for epidemiological knowledge amongst medical transactions is limited by the lack or the limitations in geographical information. With global positioning system (GPS) data incorporated in the patient identifier, and further GPS data embedded into the provider identifier, each medical transaction can include or be associated with a field for the patient unique identifier and a field for the service provider. Such patient medical transactions held in relational databases can then be accessed for analysis in a very flexible and powerful manner.

The Doclescript coding system, described in applicant's WO-0139037 entitled ‘A unitary language for problem solving resources for knowledge based services’, is based on the biological Linnean classification system. This is a widely used coding system in general practice in Australia. The Docle paradigm acts as a powerful filter for problem solving in this particular domain. The present invention includes a complementary system and method of patient unique identifiers based on geographical information, and thus provides the foundational backbone for an effective de facto national and global unique patient identifier system.

A viable solution to the problem of patient identifiers needs to involve the participation of general practitioners and of service providers at the ‘grass-root’ level, to provide continual verification and thus to ensure integrity of the personal identifier system. This process will augment the role of the administrative bodies in provision of the key services of additional verification and maintenance of the quality control and integrity of the system. Intentional and unintentional risks of system corruption can be readily detected by a doctor unable to match pathology results and hospital discharge notes. In this way, patients can be taught to value the advantages of a safe and accurate patient identifier that has as its sole aim of improving health outcomes. The integrity of the system is maintained by constant use and provider verification. Dubious patient identifier keys will be readily exposed by such use. The method provides many useful specific applications, such as a way of catering for transient overseas visitors to a local health system.

As noted above, prior art systems place total reliance on a central authority to act as an issuer/guarantor of the uniqueness of the patient identifier key. In this invention the reliance on a central authority to warrant the uniqueness of the key and its applicability for use in a distributed environment is dispensed with.

As noted above, prior art systems do not allow updating of patient databases in a global coded format and thus do not enable decision support in a seamless automated manner. This personal identifier enables the operation of a mix-in model of electronic health messaging, in which electronic messaging for human readability is also directly parseable by computer.

### DETAILED DESCRIPTION OF THE INVENTION

The invention will now be described by way of non-limiting embodiment, in the context of healthcare data.

Computerising medical transactions creates a gold mine for epidemiological research if every medical transaction carries with it two instances of embedded Global Positioning System (GPS) information. The two GPS data sets of interest are:
the place of birth of the patient, and
the location of current illness context as represented by the location of the provider.

In accordance with the present invention, the place of birth datum is incorporated as a subcomponent of a unique personal identifier. An identical unique personal identifier can be generated de novo for a given patient, at one or more service locations by service providers working incommunicado, based on information that can be readily supplied by the patient or client, informant, governmental records or birth certificate. The location of current illness context can be obtained from the healthcare provider identifier with contains embedded GPS information. Such a medical transaction, held in an SQL (STRUCTURED QUERY LANGUAGE) database, with these two vital key attributes carrying a cogent and coded medical data payload, provides an extremely rich information resource for epidemiological analysis.

The invention provides a highly cogent unique patient identifier to be used to head up an SQL (STRUCTURED QUERY LANGUAGE) transaction. This goes far beyond presently contemplated options, being an auto-generated numeric (or alphnumeric) key, or a constructed, more meaningful key, perhaps derived from personal demographic data.

The Bible provides the inspiration. Patient naming conflicts are resolved by using the typical biblical naming series found in Matthew 1:2 “Abraham was the father of Isaac; Isaac was the father of Jacob; Jacob was the father of Judah; Judah was the father of Perez . . . (Tamar was his mother) . . . ”.

In addition to the naming of forebears, in a preferred form the method of the invention uses a name of a previous issue of either parent, date of birth, sex and a geographical discriminator. The key is derived as follows with the gender expressed as s for son and d for daughter:
[first name at birth] [date of birth as expressed as number of days from 1 Jan. 1901] [s |d] “@” [first name of father] “@”[first name of mother] “@” [first name of previous_issue_of_parents] [latitude of place of birth] [longitude of place of birth]

For example, Robert was born on 17 Mar. 1988 with father David and mother Alyce. Robert is the first born son/child of David and Alyce. Robert was born in Geelong with the geographic location of latitude 38.08 south and longitude 144.21 east.

The date 17 Mar. 1988 is computed to be 31852 days since a ‘base date’ 1 Jan. 1901.

The above data generates the following Connectionless Universal Patient Identifier (CUPID):

robert31852s@david@alyce38.08s144.21e

A patient key that can be generated while service providers are working incommunicado with each other (and with any central repository of information) is described herein as ‘connectionless’. These independently generated keys for a given patient are identical, or are at least able to be matched to a high degree of confidence in order to enable aggregation and unification multi-sourced data for the same patient. The Connectionless Universal Patient Identifier (CUPID) thus provides a solution to the problem of unification of the fragmented medical record in a distributed computing environment.

The healthcare worker is identified by a provider number with a concatenated GPS location after the @ character. For example provider 77777FX located in Geelong would be:
7777FX@11.34n144.55e.

Provider GPS locations separated by a 1 minute difference, depending on latitude, are approximately 1.6 km apart, a suitable order of magnitude to pinpoint a suburban salmonella epidemic. GPS locations with a degree of accuracy to a thousandth minute (1.6 metres) are sufficient to enable pinpointing of specific beds in birth centres, so are thus ideal for perinatal research. In the scenario of a multi-storey hospital with multiple health care providers, a further degree of separation can be provided by using a datum to express the number of meters above reference ground zero level eg:
7777FX@11.34n144.55e.20

where ‘20’ denotes 20 meters above ground level at the hospital site. A provider key such as oon@11.34.001n144.55.123e.20 is therefore extremely precise and effective, as can effectively ‘zoom in’ on a particular desk at a certain floor of a hospital or clinic. With the embedded GPS data, detection of unusual epidemiological phenomena, instances of doctor shopping and other systematic abuse of the health care system can be greatly facilitated. Other benefits include:
the integrity of the CUPID system can be ensured by the continual professional verification at the service delivery level
the key itself is human-readable, it is not a meaningless string of numbers
twins and multiple birth sets are easily selected
construction of age sex registers are facilitated from the set of CUPIDs
construction of patient/country of birth registers are facilitated by the set of CUPIDs
the system embodies ‘graceful degradation’, meaning that an imperfect match between two CUPIDs does not necessarily result in a failure to match, a machine algorithm can measure the degree of match of two CUPID keys in order to provide a candidate match ranking or probability output

There remains the major issues of privacy, where such a derived key might be considered the antithesis of the anonymity associated with a more conventional string of digits. The inventor of the present invention has implemented a number of algorithm-based systems able to convert such CUPIDs into sanitised strings of characters. One such approach involves the use of symmetric-key algorithms, which use the same key for encryption and decryption. This technique takes an n-bit block of plain text as input to generate an n-bit block of cipher text. Using such a symmetric algorithm and a central custodian key, the CUPID for Robert is translated to an equally unique but obscure key:
njSDWa0UgW0m@RlEnK@6HHgzeF.H3CBGp.14P

Another variant on this technique uses namespaces to avoid key collisions, for example the health provider or service organisation with an identifier 7777FX is the custodian of the symmetric key. Robert the patient, has the fully qualified encrypted key which, by itself, can be used to derive the 2 GPS location data required:
7777FX@ njSDWa0UgW0m@RlEnK@6HHgzeF.H3CBGp.14P
   or

njSDWa0UgW0m@RlEnK@6HHgzeF.H3CBGp.14P@7777FX

This is referred to herein as the ‘palimpsest solution’ where a patient appears to have unrelated multiple identifiers linked to multiple providers, but at its core has a single, unique CUPID. For public health research, use such encrypted keys can have significant advantages. Alternatively, transactions can be de-identified by performing ‘fuzzification’ of sub-fields of the CUPIDs, such as rounding up of the date of births to the first day of each month, or obscuration of first names and other sensitive fields. An alternative technique involves the linking of the CUPIDs with arbitrary auto-increment numbers. The levels of privacy need to be contingent on the context and urgency of the patient health needs, balanced against privacy constraints and the public health imperative.

The CUPID (in its non-encrypted or encrypted form) is a suitable patient identifier for a connected health environment. In such an environment, the medical transaction must include or be associated with a unique global patient identifier key and an author key, for the purposes of remoting and re-aggregation. Embedded GPS data in the CUPID system, providing an ultimately ‘meaningful’ patient identifier, rather than an auto-generated number, has many advantages. At the same time, the cognitive need to know more about patients and disease processes and to manage patient data in a distributed manner invariably spills into privacy concerns, and the techniques of namespacing and/or use of symmetric key encryption algorithms provides an optional means of overcoming privacy concerns around the CUPID system. While the continual professional verification of a patient real identity at the service delivery level is an antidote to system entropy.

The specific approach detailed below uses a previous issue of parent and geographical discriminator. This method allows doctors working in disparate locations time and incommunicado to generate the same identifier keys and thus solve the data island problem referred to above. The derivation of key is as follows:
[first name at birth] [date of birth as expressed as number of days from 1 Jan. 1901] [s|d] “@” [first name of father] “@”[first name of mother] “@” [first name of previous_issue_of_parents] [latitude of place of birth] [longitude of place of birth]

The ‘first name of previous_issue_of_parents’ is the name of the individual's youngest older brother or sister, either on the maternal or fraternal side, possibly (of course) the same first name of the individual's father or mother. In the case of, say, a family of 5 children with same father and mother (both with no other issue from other relationships) enumerated from eldest to youngest: Jack, Jill, John, Jerry and Jeremy: the ‘first name of previous_issue_of_parents’ of John is Jill; of Jeremy is Jerry; and of Jack is nil.

For example: Robert was born on 17 Mar. 1988 with father David and mother Alyce. Robert is the first born of both David and Alyce. Robert was born in Geelong, Australia which has the geographic location of latitude 38.08 south and longitude 144.21 east. He is registered by his family doctor in the following manner:

The doctor/staff member types in the following registration screen:

Registration Screen
first name: Robert
surname: Oon
middle name: Tongsheng
fathers first name: David
mothers first name: Alyce
birthday: 17 Mar. 1988
sex: m
previous issue of parents: nil
location/town: Geelong

On clicking ‘register’ the computer program ignores the surname and middle name, and computes that 17 Mar. 1988 is 31852 days since 1 Jan. 1900.

The computer program uses a lookup resource to locate Geelong in its geographic database, returning a string comprising latitude and longitude to degress and minutes in precision: 38.08s144.21e

Robert is thus classified with the species name of:
robert31852s@david@alyce38.08s144.21e

The occurrences of just 2 @ characters indicates that Robert is the first or eldest child of both Alyce and David.

In the hypothetical example of Robert being in fact the second child, and having an older sister named Nicole, with all other data unchanged, then the key is:
robert31852s@david@alyce@nicole38.08s144.21e

The concept of the graticule, which is an area on the surface of the earth, of dimension 1 degree latitude by 1 degree longitude, is useful in illustrating the usefulness of incorporating the Global Positioning System in personal identifiers. Everyone born in this world is geographically linked to a particular graticule on this earth. A graticule varies from a maximal size of 111 km by 111 km at the equator area to an area less that 100 by 70 km near the pole. A graticule is a grid of meridians and parallels derived from a particular projection, used in drawing the map. The system used is based on modern map making predicated on the system of (1) latitude, with the equator being zero degrees (latitudes are designated as North or South of the equator. Near the equator each degree change is about 111 km; (2) longitude, based on the Greenwich meridian, being zero degrees, meridians being designated as degrees 0 to 179 East or West (180 degrees East is equivalent to 180 degrees West. The meridians become squeezed more closely together at the poles, hence the graticule dimension.

Any location in the world can thus be assigned a graticule defined by the latitude and longitude expressed as degrees (without the finer resolution of minutes). For example Melbourne geographic position is 38.08S 144.21E, hence its graticule is defined by latitude in the range 38.0.0S to 39.59.59S and longitude 144.0.0E to 144.59.59E

Using this graticule concept, in the above example, Robert (without any older sibling) can be given a grainier identifier:
robert31852s@david@alyce38s144e
   and in the alternative scenario with Nicole as his immediate older sister:

robert31852s@david@alyce@nicole38s144e

Ensuring uniqueness of patient identifier is relatively straightforward, by adding more place values and thus precision in the latitude and longitude. To get a more accurate GPS location, we need to express location GPS in degrees, minutes and thousandths of a minute. This will serve to obviate key conflict.

For example the key below, in the remote possibility that it may be non unique:
robert31852s@david@alyce@nicole38.08s144.21e
   in order to resolve any non-uniqueness of the location of the hospital or suburb of the location, the key can be resolved by a more accurate GPS system generating a more detailed key utilising (a) four hundred and forty thousandths of a minute change in the latitude and (b) one hundred and twenty thousandths of a minute change in the longitude information for the GPS such as:

robert31852s@david@alyce@nicole38.08.440s144.21.120e

Note: each minute change in a longitude and latitude of the Australian subcontinent graticule (1 degree by 1 degree) represents an area of 100 km×100 km; which approximates to 100/60 or 1.66 km, a distance that is sufficiently fine to enable distinguishing of the different location of two hospitals that are set more than 2 km apart. Modern GPS devices and systems readily extend the precision to a thousandth of a minute. This translates to a precision of 1660m divided by 1000, ie a precision of 1.6m. This degree of GPS precision is sufficient to enable identification of the exact bed of a particular ward in a maternity unit.

Because the underlying CUPID key generated is human readable, it is readily amenable to continual service provider verification of the owner.

As discussed above, while the underlying CUPID key generated is human readable, it is possible to conceal the human readable nature of the key by forward and backwards transformation protocols including but not limited to symmetric encryption and forms of representation, such as hex character arrays.

For applications of this GPS-aware CUPID key, of particular application to evaluation of the compatibility of two medical records before they are merged, the keys may be subject cross-matching checking algorithms, utilising an output involving a probability score. This cross matching of the CUPID patient identifiers is a classic example of its so-called ‘graceful degradation’ attribute, in that a small error in a CUPID patient identifier will not necessarily result in rejection of the transaction (as is the case with current systems), evoking instead a fail-safe-type system response to attempt to correct the defect.

An example of two CUPIDs:
1) yeong19191s@thean@sook@yong12n144e
2) yong19191s@thein@seok@yong12.44n144.12e

When these are processed with the CUPID cross-matcher, the output score of 94 out of 100 represents the degree fit. Heavier weightings are placed on date of birth, sex and geographic location of birth, while minor spelling errors in the first name data are lower weighted, and thus better tolerated.

The following two CUPIDs:
1) yeong19181s@thean@sook@yong12n144e
2) yong19191s@thein@seok@yong12.44n144.12e
   attract a score of only 50, as the date of birth misses the required match.

In the matching algorithm tested by the inventor, the following scores were allocated for each component match:
person first name match: 8
father first name match: 4
mother first name match: 4
previous issue fact/name match: 2
latitude/longitude graticule place of birth match: 12
date of birth match: 50
gender match: 20

By using the CUPID cross matcher the system presents the likeliest candidates that can lay claim to the imported transaction, to be followed by human verification and confirmation if appropriate.

The method of the invention can include maintaining a change log of all previously encountered CUPIDs, in order to facilitate the resolution of the patient identifier key.

The present invention also contemplates a so-called ‘mix-in model’ of global medical messaging using the connectionless patient identifiers (CUPIDs) described above.

The invention of a connectionless universal patient identifier is the basis of an atomic global health messaging entity termed an ‘ehrtom’ (electronic health record+tom). An ehrtom is defined as the simplest indivisible stand-alone global health message. It is jurisdiction independent. An ehrtom is equivalent to a single proposition (or ‘transaction’) concerning a specific unique patient. Functionally, it can also be viewed as the smallest unit of self-organising electronic health record. In this view, an erhtom is a micro stand-alone health record, that is generated in an autonomous manner in time and place, that conveys a useful medical payload. It comprises a CUPID and a medical proposition about the patient written in a health language such as Doclescript. Ehrtom can be interspersed in medical/pathology English text reports as a mix-in to form a composite medical message comprising both natural language text and coded medical messages. An ehrtom comprises the following components in EBNF.

This formal definition is based on Extended Backus Naur Formalism (EBNF is discussed in ‘Programming in Modula 2’, by Nildaus Wirth, Springer-Verlag, 1982).

EBNF Syntax rules are defined as:

Syntax = { rule }.
rule = identifier “=“ expression “.”.
expression = term { “|” term }.
term = factor { factor }.
factor = identifier | string | “(“ expression “) ” | “[“ expression “]” | “{“
expression “}”.
The right hand of each rule defines syntax based on previous rules and
terminal symbols.
Parentheses such as ( ) group alternate terms.
The vertical bar | separates alternate terms.
Square brackets [ ] denote optional expressions.
Braces { } denote expressions that may occur zero or more times.
An ehrtom definition is a sequence of syntax rules.
“cpid[“personal_identifier”] “[date_record_created][date_event] block |
unitary_health_language_proposition [note] [author] [coda]
personal_identifier = Connectionless universal patient identifier
block = “[“ { unitary_health_language_proposition} “]”
date_record_created = “date[“,date”]”
date_event = “on[“,date”]”
note = “,note[“comment”]”
author=“,auth[“author”]”
unitary_health_language_proposition = a high level health language
proposition, an example being &ctx@hx[cough;chest@pain;dyspnea],
for[2/7]
coda=“,coda[“version”]”

The coda denotes the version number of the ehrtom.

The coda[v1.0] indicates that the transaction is typed version 1.0 and conforms to the standards and coding prevalent in version 1.0.

An example of an ehrtom is:
cpid[john37409d@kuang@mary31.57n35.56e],date[2003/6/10],on[2003/6/10]&c tx@hx[cough;chest@pain;dyspnea],for[2/7],note[ ],auth[474603X@144.12s34.55 e],coda[v1.0]

The ehrtom can be described as a ‘block riding language’, as its message contents are clearly demarcated within blocks marked out by pairs of square parentheses.

An example of this mix-in type of medical messaging utilises the insertion of ehrtom in the text container section of the PIT pathology format messaging systems used in Australia:

301 >1:640 = High Titre
301
cpid[robert31852s@david@alyce38.08s144.21e],date[2003/6/10],
on[2003/6/10] &ctx@ix[autoAntibodies@antiNuclear],find[positive],
note[],auth[474603X@144.12s34.55e],coda[v1.0]
301
301 AB
309
390 End of Report :
399 -------------------------------------------------------------------------------

Line 301 is a comment section. The ehrtom can be readily identified by its CUPID header cpid. A parser can be readily constructed to pick up the line with the cpid identifier, extract the personal identifier, and extract the message contents to be inserted into the appropriate medical record. Hence an ehrtom can be used to piggyback other messaging protocols.

Likewise this mix-in method can be applied to a doctors report that comes in as a word processed document or as email text.

An example of a specialist report with normal language text and an appended block version of ehrtom comprising more than one proposition:

Dear Dr Smith,
Thank you for sending me patient Robert Oon who has chest pains on exertion. He gave a convincing history of effort angina. He was found to be mildly hypertensive. He had a positive stress test on 23 May 2002 and he proceeded to angiography. This showed minimal RCA disease and I have started him on imdur 60 mg one daily, coversyl od, lipitor 40 mg od. He will be reviewed in 2/12.

Yours faithfully

Duncan (Cardiologist)

cpid[robert31852s@david@alyce38.08s144.21e],date[2003/6/10],on[2003/
6/10]
[&ctx@dx@+[ischemicHeartDisease]
&ctx@dx@+[hyperTension]
&ctx@dx@+[anginaPectoris]
&ctx@rx[peri-ndopril] ,tn[coversyl],dose[4mg],freq[1/7],
for[hyperTension]
&ctx@rx[isosorbideMononitrate],tn[imdur],dose[60mg],freq[1/7],
for[anginaPectoris]
&ctx@rx[atorvastatin],tn[lipitor],
dose[40mg],freq[1/7],for[ischemicHeartDisease] ] ,
note[ ],auth[474603X@144.12s34.55e],coda[v1.0]

-end letter-

This method of mixing ehrtoms in with human readable text allows for human verification of correctness of health messaging, vital in the modern global healthcare environment. Each coded transaction is headed by the term cpid and with the connectionless personal identifier held inside the first pair of square parentheses heads up the medical transactional message. These medical messages can be buried in email and pathology reports to effect easy delivery of coded cogent data that is verifiable by the human eye and that is computer parseable to extract the contents of the message to be inserted in the right medical record.

This mix-in model can extend to a complete patient held medical file containing natural human readable ten about the patient health record and a complete series of ehrtom to decribe a complete longitudinal medical record. A series of ehrtom to describe a comprehensive medical record is termed freshEhr.

In one embodiment, the freshEhr has a change log of to track all the CUPIDS used to update a particular patient medical record.

For example an ehrtom with cpid of
kuang12324244s@thean@sook@yong12.34n12.57e
   is used to update a medical record with two previous variants of CUPID:
kuang12324244s@thean@soook@yong12.34n12.56e
kuan12324244s@thean@sook@yong12.34n12.56e
   The correct CUPID is placed as the first member of collection log of CUPIDs that is appended at the end of a freshehr file, in order to convey a historical record of all previously used CUPID to describe the patient.
log[kuang12324244s@thean@sooook@yong12.34n12.56e
kuang12324244s@thean@sook@yong12.34n12.56e
kuang12324244s@thean@soook@yong12.34n12.57e

This logging of all previously used CUPIDs aids in resolving to the correct patient identifier.

The universal patient identifier system described above, used with a medical scripting language, therefore affords a mix-in model for medical messaging of isolated medical transactions to a complete representation of the whole of patient medical record suitable for computer input. This format therefore allows reliable reaggregation and unification of disparate transaction records for a single patient. The technique thus provides means for a complete global portable health record for an individual.

Importantly, the coded cogent data format of the transaction propositions (CUPID plus coded transaction) is readily verifiable by the human eye and at the same time, readily computer parseable.

For purposes of global health messaging, the embedded patient date of birth data is enhanced by use of embedding a location identifier (expressed in similar GPS format, in latitude and longitude) in a provider identifier.

The present invention has been described above with reference to a unique patient identifier system for use with transaction data relating to the healthcare environment. As the skilled reader will appreciate, the invention also has application in a wide variety of other contexts, such as the fields of education, finance and banking, social security, law enforcement and security, passport regimes, and employment. In certain applications, such as those relating to financial transactions, that the personal identifier of the invention is human readable means that a person knowingly using a wrongful identifier would be deemed to be committing perjury at the same time as committing identity fraud, and this fact would assist in deterring fraudulent transactions or other activities.

The personal identifier system described above can be used as an accessory verifier to establish confirmation of identity of an individual. In such application, the personal identifier of the invention can also be used in a parallel with other modes of client identification (such as passport number, bank id, Medicare or NHS number).

The personal identifier in this invention is human readable, a person knowingly using such a wrongful identifier would be committing perjury at the same time as committing identity theft. This feature would be beneficial to deter fraud in the finance/banking sector

Modifications and improvements to the invention will be readily apparent to those skilled in the art. Such modifications and improvements are intended to be within the scope of this invention.

Glossary of Terms Used in this Specification

CUPID—Connectionless Universal Personal Identifier key, being a unique global health ID
GPS—Geographic Positioning System
ID—identifier/identity
DOCLESCRIPT—standard for medical coding of transactional data in Extended Backus Naur notation. Doclescript is a quasi-natural alphabetic language of medicine suitable for machine processing, the Docle framework modelled on the hierarchical linnean biological classification system, having multiple inheritance. The system is described in further detail in applicant's WO-0139037 entitled ‘A unitary language for problem solving resources for knowledge based services’.
ehrTom—the smallest unit of self organising electronic health records. A micro stand-alone health record that is generated in an autonomous manner in time and place, that conveys a useful medical payload. It comprises of a CUPID and a doclescript transaction. It can be interspersed in medical/pathology English text reports.
ehrTom bot—A self organizing ehrTom, being a bot (a roBOT, a computer program able to performs a repetitive function such as searching for information) that is instantiated with an ehrTom or a moleculEhr, and which then proceeds to incorporate the ehrTom/moleculEhr with the rest of the freshEhr associated with that patient. The EhrTom bot is designed to prompt or dump an error message (according to the bot settings) with payload contents in the event of failure to achieve its mission.
moleculEhr—A variant of ehrTom that carries a bigger payload. It is a CUPID and a block of doclescript propositions/transactions, rather than a single proposition/transaction. Like an erhTom, it can be interspersed in medical/pathology English text reports.
freshEhr—conglomeration of multiple ehrTom and moleculEhr that represents a partial or complete patient electronic health record. It can be interspersed in medical/pathology English text reports as a mix-in technology to represent a complete portable medical report.
freshEhr analyzer—a module designed to check for alerts/faults/incongruencies of freshEhr.

1. A method of uniquely associating transaction data with a particular individual, comprising the steps of:
generating or obtaining transaction data for that individual; and
associating the transaction data with a unique personal identification key of that individual, the key expressed in human readable form and comprising a representation of the individual's first or given name, the individual's father's first or given name, the individual's mother's first or given name, the individual's date of birth, the individual's gender, and the individual's place of birth expressed in longitude and latitude.

2. The method of claim 1, wherein the unique personal identification key further comprises the first or given name of previous issue of either parent.

3. The method of claim 1, wherein the method includes the step of transforming the human readable form of the key into a non-human readable form and, optionally, the further retransformation of the non-human readable form of the key back into human readable form.

4. The method of claim 1, wherein the individual's place of birth is expressed in terms of degrees and minutes.

5. The method of claim 1, wherein the individual's place of birth is expressed in terms of degrees, minutes, tenth-minutes, hundredth-minutes and thousandth-minutes.

6. The method of claim 1, wherein the association of the data transaction with a unique personal identification key, or the association of disparate data transactions each associated with non-identical keys, includes the step of, evoking an indication of a degree of match, being a probability of correctness of match.

7. The method of claim 6, wherein, in the event of a non-perfect match of a particular key or keys, a candidate list of likely keys is evoked, each candidate associated with a probability or ranking to indicate a degree of match.

8. The method of claim 6, wherein the degree of match is generated in accordance with an algorithm biasing the probability of match in favour of characteristics selected from the group of gender, date of birth, place of birth and existence of a previous issue.

9. The method of claim 1, wherein the transaction data is expressed in a machine parsable scripting language.

10. The method of claim 9, the machine parsable scripting language having an organised and classified vocabulary of terms which derive from a natural human language to facilitate ease of comprehension by humans, the language based upon the use of expressions containing said terms and representing items of information, wherein said expressions selectively include contextual code components to provide a context of an item of information, the contextual code components comprising terms from said vocabulary, each term able to embody both an intrinsic meaning and a place value significance, the place value significance augmenting the meaning of the resultant expression depending on the positional relationship of the term to a contextual code component, so to provide a transaction proposition applicable to global messaging.

11. The method of claim 9, wherein the unique personal identification key forms the header of each transaction proposition.

12. The method of claim 9, wherein each transaction proposition comprises an English text component for direct human apprehension, and a coded component for direct computer input.

13. The method of claim 9, wherein each transaction proposition includes a representation of a further location, being the location of the transaction.

14. The method of claim 1, wherein the unique personal identification key or the transaction proposition further comprises a representation of altitude of location of place of birth or of the location of the transaction.

15. The method of claim 9, for global messaging of transaction data, including the step of constructing a message block from a series of transaction propositions held headed by a single unique personal identification key.

16. The method of claim 1, wherein the transaction data is patient healthcare data, and the unique personal identification key identifies a patient.

17. The method of claim 1, wherein the unique personal identification key identifies an individual in a law enforcement context.

18. The method of claim 1, wherein the unique personal identification key identifies a world wide web domain name for web services for a global citizen.

19. A computer-based messaging system for communicating data relating to particular individuals, comprising messages in a format of one or more blocks of data expressed in a machine parsable scripting language together with a unique personal identification key for said particular individual, the key comprising a representation of a combination of the individual's first or given name, the individual's father's first or given name, the individual's mother's first or given name, the individual's date of birth, the individual's gender, and the individual's place of birth expressed in longitude and latitude.

20. The system of claim 19, wherein the unique personal identification key further comprises a representation of the first or given name of previous issue of either parent.
